(19) United States
(12) Patent Application Publication
(10) Pub. No.: US 2025/0183612 A1
(43) Pub. Date: Jun. 5, 2025

(54) CONNECTION ASSEMBLY FOR A FEED FIBER

(71) Applicant: Lumentum Operations LLC, San Jose, CA (US)

(72) Inventors: Alen BUCAR, Trebnje (SI); Andraž HLASTEC, Ljubljana (SI); Tomaž JERMAN, Crnomelj (SI)

(21) Appl. No.: 18/428,552

(22) Filed: Jan. 31, 2024

Related U.S. Application Data
(60) Provisional application No. 63/604,525, filed on Nov. 30, 2023.

(51) Int. Cl. H01S 3/094; H01S 3/04; H01S 3/067

(52) U.S. Cl. CPC H01S 3/094053; H01S 3/0407; H01S 3/06704; H01S 3/094042

(57) ABSTRACT

In some implementations, a connection assembly includes a sleeve body defining a sleeve, a first electrical contact element embedded in the sleeve body, and a second electrical contact element embedded in the sleeve body, where the sleeve body electrically isolates the first electrical contact element from the second electrical contact element. The connection assembly may include a first wire electrically connected to the first electrical contact element within the sleeve body, and a second wire electrically connected to the second electrical contact element within the sleeve body.

### CROSS-REFERENCE TO RELATED APPLICATION

This Patent Application claims priority to U.S. Provisional Patent Application No. 63/604,525, filed on Nov. 30, 2023, and entitled “CONTACT RING ASSEMBLY.” The disclosure of the prior Application is considered part of and is incorporated by reference into this Patent Application.

### TECHNICAL FIELD

The present disclosure relates generally to lasers and to a connection assembly for a feed fiber.

### BACKGROUND

A fiber laser is a laser in which an active gain medium is an optical fiber doped with an element capable of providing gain, such as erbium, ytterbium, neodymium, dysprosium, praseodymium, thulium, holmium, bismuth, or the like. A high-power fiber laser is a fiber laser that is capable of delivering a relatively high output power. For example, the output power of a high-power fiber laser may be in a range from tens of watts to several kilowatts.

### SUMMARY

In some implementations, a laser system includes a laser source, a laser system output having a connector, and a feed fiber assembly, configured to optically couple the laser source to the laser system output. The feed fiber assembly may include a cooling assembly configured for connection to the connector, and a connection assembly mounted on the cooling assembly and configured to establish an electrical connection with the connector. The connection assembly may include a sleeve body defining a sleeve, a first electrical contact element embedded in the sleeve body, and a second electrical contact element embedded in the sleeve body, where the sleeve body electrically isolates the first electrical contact element from the second electrical contact element.

In some implementations, a feed fiber assembly includes an optical fiber and a cooling assembly including a housing having a fluid inlet and a fluid outlet, where the optical fiber extends through the cooling assembly. The feed fiber assembly may include a connection assembly mounted on the cooling assembly. The feed fiber assembly may include a sleeve body defining a sleeve, a first electrical contact element embedded in the sleeve body, and a second electrical contact element embedded in the sleeve body, where the sleeve body electrically isolates the first electrical contact element from the second electrical contact element, and where the sleeve body electrically isolates the housing from the first electrical contact element and the second electrical contact element.

In some implementations, a connection assembly includes a sleeve body defining a sleeve, a first electrical contact element embedded in the sleeve body, and a second electrical contact element embedded in the sleeve body, where the sleeve body electrically isolates the first electrical contact element from the second electrical contact element. The connection assembly may include a first wire electrically connected to the first electrical contact element within the sleeve body, and a second wire electrically connected to the second electrical contact element within the sleeve body.

### BRIEF DESCRIPTION OF THE DRAWINGS

FIG. 1 is a diagram illustrating an example laser system.

FIG. 2 shows a perspective view of an example connection assembly.

FIG. 3 is a cross-sectional view of the connection assembly of FIG. 2 taken along line A-A.

FIG. 4 is a flowchart of an example process associated with manufacturing a connection assembly.

### DETAILED DESCRIPTION

The following detailed description of example implementations refers to the accompanying drawings. The same reference numbers in different drawings may identify the same or similar elements.

Fiber lasers are a class of lasers that provide significant advantages of efficiency and practicality in comparison with other laser types, such as free-space lasers. In fiber lasers, light is guided by an active fiber core typically doped with ions of a rare-earth element, such as ytterbium or erbium, which provides optical gain. The guiding property of the doped fiber core considerably relaxes requirements of optical alignment, and allows increases to the length of the gain medium to tens and even hundreds of meters, resulting in very high achievable optical gains. For example, using double-clad fiber (DCF), fiber lasers can be scaled to kilowatt (kW) power levels.

The light output from a high-power fiber laser may be coupled into a feed fiber that is used to deliver the light for applications such as laser cutting, laser welding, or the like. Because of the high power output of the fiber laser, various measures may be employed to address overheating and accidental laser discharge. For example, the feed fiber may include a cooling assembly (e.g., a cooling channel) that provides fluid cooling of the feed fiber. Moreover, the cooling assembly may be configured for connection to a connector using an interlock that prevents operation of the high-power fiber laser when the feed fiber is disconnected. For example, the cooling assembly may include electrical contacts (e.g., contact pads or contact rings) that, when engaged with a conductive surface (e.g., pins) of the connector, close an electrical circuit to signal that the high-power fiber laser can be activated.

Generally, the electrical contacts may be attached to the cooling assembly using a system of spacer rings. For example, multiple spacer rings that insulate the electrical contacts from the cooling assembly and from each other may be assembled, together with the electrical contacts and associated wiring, onto the cooling assembly. As an example, assembling the spacer rings and electrical contacts may involve sliding, onto the cooling assembly and in sequence, a first spacer ring, a first electrical contact, a second spacer ring, a second electrical contact, and a third spacer ring. Furthermore, during assembling of the spacer rings and electrical contacts, wires for the electrical contacts are threaded through the spacer rings. Accordingly, this assembling of the spacer rings, electrical contacts, and associated wiring demands great care, is time consuming, and is susceptible to out-of-specification assembling.

Additionally, during use of the cooling assembly, mishandling of the cooling assembly or other mechanical influences may cause translation, rotation, or other movement of the spacer rings and the electrical contacts. As a result, the electrical contacts may become misaligned, thereby preventing proper closing of the electrical circuit and/or proper operation of the high-power fiber laser. Furthermore, the electrical contacts may be rotated to a degree that causes disconnection of the wiring to the electrical connects, thereby resulting in electrical shorts and/or a circuit break.

Some implementations described herein provide a connection assembly that is unitary and that can be installed on a cooling assembly as a single component. In some implementations, the connection assembly includes a sleeve body, defining a sleeve, and a set of electrical contact elements embedded in the sleeve body, thereby fixing the positions of the electrical contact elements. Moreover, the sleeve body provides electrical isolation between the electrical contact elements, as well as between the electrical contact elements and the cooling assembly. The unitary nature of the connection assembly allows the positioning of the electrical contact elements on the sleeve body to be tightly controlled, thereby facilitating accurate alignment of the electrical contact elements. Additionally, fixing the positions of the electrical contact elements provides resistance to shifting or other movements that would otherwise result from mishandling or other mechanical influences on the cooling assembly. Accordingly, the connection assembly can consistently produce a reliable electrical connection with the connector even over the course of many uses. Furthermore, the connection assembly can be kept in an inventory as a single component, thereby reducing the need for an excessive and burdensome parts inventory.

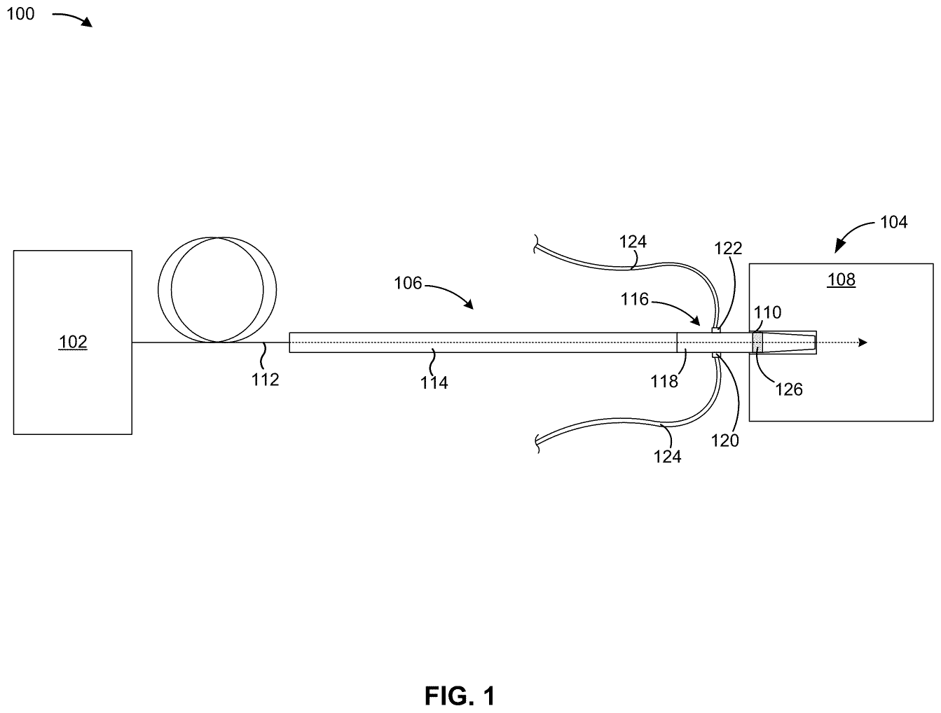

FIG. 1 is a diagram illustrating an example laser system 100. As shown, the laser system 100 includes a laser source 102, a laser system output 104, and a feed fiber assembly 106.

The laser source 102 may include any device or combination of devices that generates laser light. For example, the laser source 102 may include a single laser or a group of lasers coupled into a single output. In some implementations, the laser source 102 may include a fiber laser (e.g., including an optical fiber doped with an element capable of providing optical gain, such as erbium or ytterbium, in an optical cavity) and/or a fiber amplifier. The fiber laser may be a high-power fiber laser (e.g., having an output power of tens of watts to several kilowatts).

The laser system output 104 may include an optical output of the feed fiber assembly 106 and/or a connector 108 (e.g., a mechanical structure) configured to hold the feed fiber assembly 106 in a particular positioning for a laser application, such as laser cutting, laser drilling, laser welding, or the like. The connector 108 may be configured for physical and/or electrical connection and disconnection with the feed fiber assembly 106. For example, the connector 108 may include an electrically-conductive surface 110 (e.g., a set of conductive pins) configured to facilitate detection of a connection between the feed fiber assembly 106 and the connector 108, as described below. In some implementations, the connector 108 may include a receptacle, a port, or the like, into which the feed fiber assembly 106 can be inserted. In some implementations, the connector 108 may include one or more lenses, one or more mirrors, and/or other optical elements or devices configured to direct and/or focus light onto a target.

The feed fiber assembly 106 may include an optical fiber 112 and a protective jacket 114 that surrounds a section of the optical fiber 112. The feed fiber assembly 106 may optically couple the laser source 102 to the laser system output 104. For example, a first end (e.g., a back end) of the feed fiber assembly 106 may be optically coupled to the laser source 102. As an example, the optical fiber 112 may be optically coupled to an output of the laser source 102 (e.g., an output of the fiber laser). A second end of the feed fiber assembly 106 may terminate with a cooling assembly 116 (e.g., a cooling channel or a water channel). For example, at the second end of the feed fiber assembly 106, the optical fiber 112 may extend through the cooling assembly 116. The cooling assembly 116 may be configured to provide cooling of the optical fiber 112 and/or the connector 108. Moreover, the cooling assembly 116 may be configured for connection to the connector 108.

The cooling assembly 116 may include a housing 118 (e.g., that surrounds a section of the optical fiber 112). The housing 118 may be configured to mate with the connector 108. For example, the housing 118 may be cylindrical and may taper inward toward an end of the housing 118 to facilitate insertion of the cooling assembly 116 into a receptacle, a port, or the like, of the connector 108. The housing 118 may have a fluid inlet 120 into the housing 118 and a fluid outlet 122 out from the housing 118. The fluid inlet 120 may be coupled to a fluid conduit 124 (e.g., a hose) configured to supply fluid (e.g., a liquid, such as water, or a gas such as air) to the fluid inlet 120. The fluid outlet 122 may be coupled to a fluid conduit 124 (e.g., a hose) configured to direct the fluid out from the housing 118. A fluid path (not shown) may extend within the housing 118 between the fluid inlet 120 and the fluid outlet 122. The fluid path may be configured to thermally interact with the optical fiber 112 (e.g., to cool the optical fiber 112). In some implementations, the housing 118 may be composed of an electrically-conductive material, such as a metal or a metal alloy.

The feed fiber assembly 106 may include a connection assembly 126 mounted on the cooling assembly 116. For example, the connection assembly 126 may be positioned on the housing 118. As an example, the housing 118 may have a recessed region (e.g., extending circumferentially around the housing 118), and the connection assembly 126 may be positioned in the recessed region (e.g., to restrict the connection assembly 126 from sliding off of the cooling assembly 116). When the cooling assembly 116 is connected to the connector 108, the connection assembly 126 may establish an electrical connection with the electrically-conductive surface 110. The electrical connection may close a circuit, thereby permitting the laser source 102 to operate.

As indicated above, FIG. 1 is provided as an example. Other examples may differ from what is described with regard to FIG. 1.

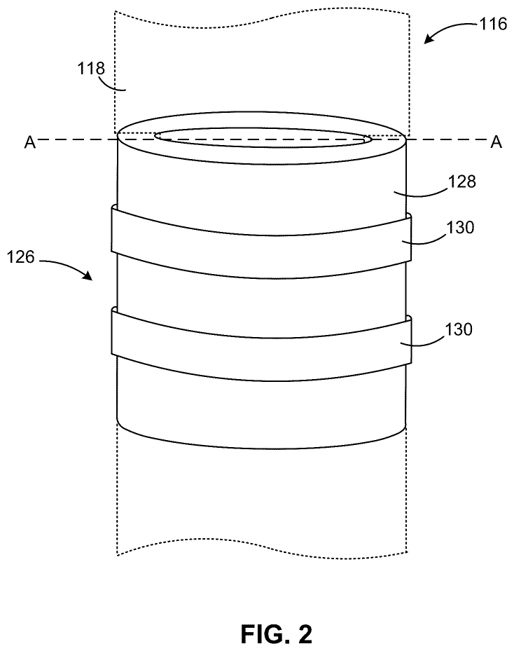

FIG. 2 shows a perspective view of an example connection assembly 126. In FIG. 2, the connection assembly 126 is shown mounted on the housing 118 of the cooling assembly 116 (shown in dashed line).

The connection assembly 126 includes a sleeve body 128 (e.g., a molded sleeve body) and a set of electrical contact elements 130 (e.g., a first electrical contact element 130 and a second electrical contact element 130) embedded in the sleeve body 128. In some implementations, the electrical contact elements 130 may include contact rings (e.g., annular-shaped electrical contacts).

The sleeve body 128 defines a sleeve. For example, the sleeve body 128 includes a side wall (e.g., that is continuous) that defines an opening through the sleeve body 128 (e.g., the sleeve body 128 is open at both ends of the sleeve body 128). For example, the sleeve body 128 may have the shape of a hollow cylinder or another hollow geometry. Thus, the sleeve body 128 has an interior surface (e.g., surrounding the opening through the sleeve body 128) and an exterior surface.

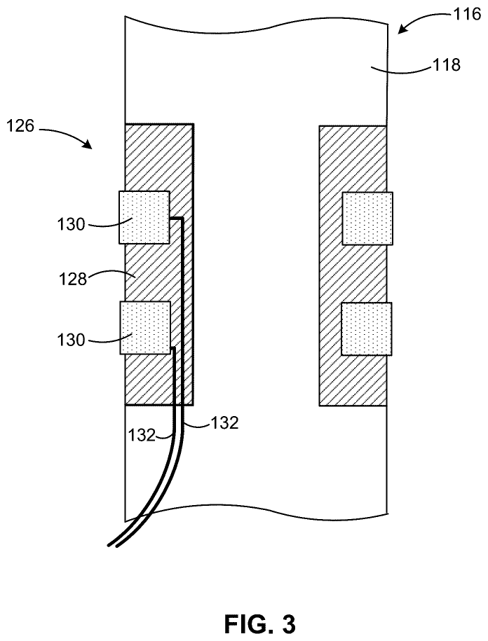

The electrical contact elements 130 are embedded in the sleeve body 128. Embedding the electrical contact elements 130 in the sleeve body 128 may fix a position of the electrical contact elements 130 relative to the sleeve body 128. The electrical contact elements 130 may be embedded in the sleeve body 128 such that the electrical contact elements 130 are exposed at the exterior surface of the sleeve body 128 (e.g., thereby allowing the electrical contact elements 130 to electrically contact the electrically-conductive surface 110 of the connector 108). Moreover, the electrical contact elements 130 may be embedded in the sleeve body 128 such that a region of the sleeve body 128 is between the interior surface of the sleeve body 128 and the electrical contact elements 130 (e.g., the electrical contact elements 130 are not exposed at the interior surface of the sleeve body 128, thereby restricting electrical contact between the electrical contact elements 130 and the metallic housing 118 of the cooling assembly 116), as shown in FIG. 3.

The sleeve body 128 may be composed of a material that is electrically isolating (e.g., an electrically-insulating material). Moreover, the material may be rigid. Furthermore, the material may be a thermosetting material. For example, the sleeve body 128 may be composed of polyoxymethylene (POM) or another plastic. In some implementations, the sleeve body 128 may include a polymer matrix in which the electrical contact elements 130 are embedded. For example, the sleeve body 128 may be an over-molding on the electrical contact elements 130. The electrical contact elements 130 may be composed of an electrically-conductive material, such as a metal or a metal alloy (e.g., copper). Accordingly, the sleeve body 128 may electrically isolate the first electrical contact element 130 from the second electrical contact element 130. Furthermore, the sleeve body 128 may provide electrical isolation between the electrical contact elements 130 and the housing 118 of the cooling assembly 116.

In some implementations, the connection assembly 126 may employ one or more locking features configured to restrict rotation of the sleeve body 128 about the housing 118 of the cooling assembly 116. For example, an aperture through the sleeve body 128 may be configured to align with an aperture or cavity in the housing 118 of the cooling assembly 116 when the connection assembly 126 is positioned on the housing 118. The connection assembly 126 may include a pin insertable into the aperture through the sleeve body 128 and into the aperture or cavity in the housing 118, to thereby lock the position of the connection assembly 126 on the housing 118. As another example, the sleeve body 128 may have a non-circular cross-section (e.g., a D-shaped cross-section, a square-shaped cross-section, or an oval-shaped cross-section, among other examples), and a region of the housing 118 on which the connection assembly 126 is positioned (e.g., the recessed region of the housing 118) may have a corresponding cross-sectional shape. Accordingly, when the connection assembly 126 is positioned on the housing 118, the non-circular cross-sections of the sleeve body 128 and the housing 118 restrict rotation of the connection assembly 126.

The connection assembly 126 is a unitary part that can be installed on the cooling assembly 116 as a single component. The unitary nature of the connection assembly 126 allows the positioning of the electrical contact elements 130 on the sleeve body 128 to be tightly controlled, thereby facilitating accurate alignment between the electrical contact elements 130 and the electrically-conductive surface 110 of the connector 108. For example, connection of the cooling assembly 116 and the connector 108 may complete an electrical circuit via contact of the electrical contact elements with the electrically-conductive surface 110.

Moreover, the unitary nature of the connection assembly 126 fixes the positions of the electrical contact elements 130 relative to the sleeve body 128. In this way, the electrical contact elements 130 are resistant to shifting or other movements that would otherwise result from mishandling or other mechanical influences on the cooling assembly 116. Accordingly, the connection assembly 126 can consistently produce a reliable electrical connection with the connector 108 even over the course of many uses. Furthermore, the connection assembly 126 can be kept in an inventory as a single component, thereby reducing the need for an excessive and burdensome parts inventory.

As indicated above, FIG. 2 is provided as an example. Other examples may differ from what is described with regard to FIG. 2.

FIG. 3 is a cross-sectional view of the connection assembly 126 of FIG. 2 taken along line A-A.

As shown, the connection assembly 126 may include a set of wires 132 (e.g., a first wire 132 and a second wire 132). A wire 132 may include any type of electrically-conductive connector. The wires 132 extend along the sleeve body 128 and are electrically connected to respective electrical contact elements 130. For example, the electrical connections between the wires 132 and the electrical contact elements 130 may be buried in the sleeve body 128 between the exterior surface and the interior surface of the sleeve body 128. The wires 132 may extend through the sleeve body 128 (e.g., from points where the wires 132 electrically connect to the electrical contact elements 130) and protrude out from an end of the sleeve body 128 (e.g., the wires 132 may protrude from the same end of the sleeve body 128).

As indicated above, FIG. 3 is provided as an example. Other examples may differ from what is described with regard to FIG. 3.

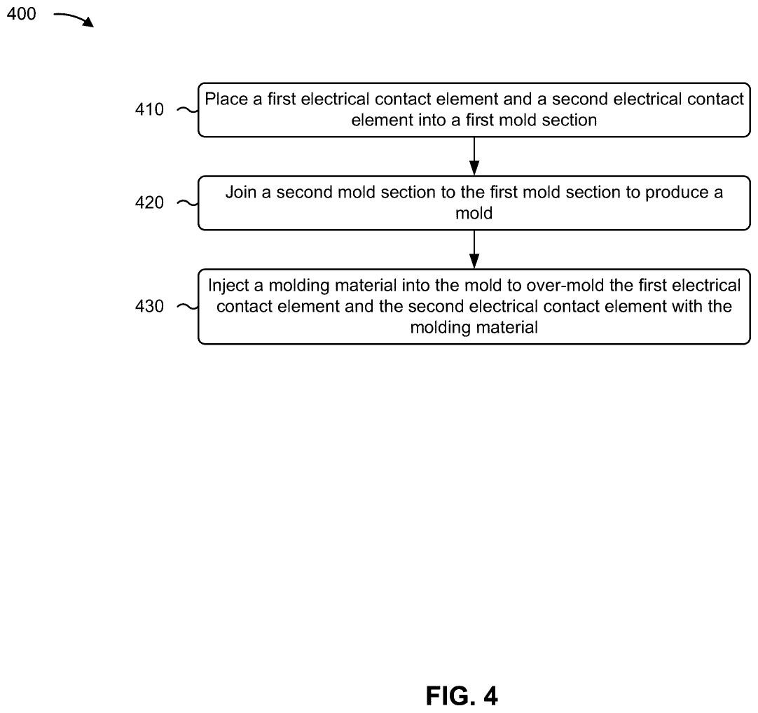

FIG. 4 is a flowchart of an example process 400 associated with manufacturing a connection assembly. In some implementations, one or more process blocks of FIG. 4 are performed by manufacturing equipment, such as injection molding equipment.

As shown in FIG. 4, process 400 may include placing a first electrical contact element and a second electrical contact element into a first mold section (block 410). For example, the first mold section may include retention features that retain positions of the first electrical contact element and the second electrical contact element in the first mold section. When placed in the first mold section, the first electrical contact element may be spaced apart from the second electrical contact element. In some implementations, process 400 includes placing a first wire into the first mold section in electrical contact with the first electrical contact element, and placing a second wire into the first mold section in electrical contact with the second electrical contact element. An electrical connection between a wire and an electrical contact element may be formed by solder or electrically conductive adhesive, by wrapping the wire around the electrical contact element, by placing the wire in contact with the electrical contact element, or the like.

As further shown in FIG. 4, process 400 may include joining a second mold section to the first mold section to produce a mold (block 420). In some implementations, the second mold section may also include retention features that retain positions of the first electrical contact element and the second electrical contact element. In some implementations, the first wire and the second wire may extend outside of the mold (e.g., via apertures in the first mold section and/or the second mold section).

As further shown in FIG. 4, process 400 may include injecting a molding material into the mold to over-mold the first electrical contact element and the second electrical contact element with the molding material (block 430). The molding material may also encapsulate the wires. The molding material may include an electrically isolating material, such as a plastic, as described herein. Injecting the molding material into the mold may produce the connection assembly (e.g., connection assembly 126). For example, the mold may be configured to form the molding material into a sleeve body with the first electrical contact element and the second electrical contact element (as well as the wires) embedded therein, as described herein.

In some implementations, process 400 may include curing the molding material injected into the mold. In some implementations, process 400 may include separating the first mold section and the second mold section, and removing the connection assembly from the mold.

Although FIG. 4 shows example blocks of process 400, in some implementations, process 400 includes additional blocks, fewer blocks, or different blocks than those depicted in FIG. 4.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A laser system, comprising:
a laser source;
a laser system output having a connector; and
a feed fiber assembly, configured to optically couple the laser source to the laser system output, comprising:
a cooling assembly configured for connection to the connector; and
a connection assembly, mounted on the cooling assembly and configured to establish an electrical connection with the connector, comprising:
a sleeve body defining a sleeve;
a first electrical contact element embedded in the sleeve body; and
a second electrical contact element embedded in the sleeve body,
wherein the sleeve body electrically isolates the first electrical contact element from the second electrical contact element.

2. The laser system of claim 1, wherein the cooling assembly includes a housing, a fluid inlet into the housing, a fluid outlet out from the housing, and a fluid path, within the housing, between the fluid inlet and the fluid outlet.

3. The laser system of claim 2, wherein the sleeve body has a non-circular cross-section corresponding to a non-circular cross-section of a region of the housing on which the connection assembly is positioned.

4. The laser system of claim 2, wherein the sleeve body electrically isolates the first electrical contact element and the second electrical contact element from the housing.

5. The laser system of claim 1, wherein the feed fiber assembly includes an optical fiber that extends through the cooling assembly.

6. The laser system of claim 1, wherein the connector includes an electrically-conductive surface, and
wherein connection of the cooling assembly and the connector is to complete an electrical circuit via contact of the first electrical contact element and the second electrical contact element with the electrically-conductive surface.

7. The laser system of claim 1, wherein the connection assembly further comprises:
a first wire electrically connected to the first electrical contact element within the sleeve body,
wherein the first wire extends through the sleeve body and protrudes from the sleeve body at an end of the sleeve body; and
a second wire electrically connected to the second electrical contact element within the sleeve body,
wherein the second wire extends through the sleeve body and protrudes from the sleeve body at the end of the sleeve body.

8. A feed fiber assembly, comprising:
an optical fiber;
a cooling assembly comprising a housing having a fluid inlet and a fluid outlet,
wherein the optical fiber extends through the cooling assembly; and
a connection assembly, mounted on the cooling assembly, comprising:
a sleeve body defining a sleeve;
a first electrical contact element embedded in the sleeve body; and
a second electrical contact element embedded in the sleeve body,
wherein the sleeve body electrically isolates the first electrical contact element from the second electrical contact element, and
wherein the sleeve body electrically isolates the housing from the first electrical contact element and the second electrical contact element.

9. The feed fiber assembly of claim 8, further comprising a jacket that surrounds a section of the optical fiber.

10. The feed fiber assembly of claim 8, wherein the housing has a recessed region, and wherein the connection assembly is positioned in the recessed region.

11. The feed fiber assembly of claim 8, wherein the sleeve body has an interior surface and an exterior surface,
wherein the first electrical contact element and the second electrical contact element are exposed at the exterior surface, and
wherein a region of the sleeve body is between the interior surface, and the first electrical contact element and the second electrical contact element.

12. The feed fiber assembly of claim 8, wherein the sleeve body has a non-circular cross-section corresponding to a non-circular cross-section of a region of the housing on which the connection assembly is positioned.

13. The feed fiber assembly of claim 8, wherein the connection assembly further comprises:
a first wire electrically connected to the first electrical contact element within the sleeve body,
wherein the first wire extends through the sleeve body and protrudes from the sleeve body at an end of the sleeve body; and
a second wire electrically connected to the second electrical contact element within the sleeve body,
wherein the second wire extends through the sleeve body and protrudes from the sleeve body at the end of the sleeve body.

14. The feed fiber assembly of claim 8, wherein the sleeve body is an over-molding on the first electrical contact element and the second electrical contact element.

15. A connection assembly, comprising:
a sleeve body defining a sleeve;
a first electrical contact element embedded in the sleeve body;
a second electrical contact element embedded in the sleeve body,
wherein the sleeve body electrically isolates the first electrical contact element from the second electrical contact element;
a first wire electrically connected to the first electrical contact element within the sleeve body; and
a second wire electrically connected to the second electrical contact element within the sleeve body.

16. The connection assembly of claim 15, wherein the sleeve body is an over-molding on the first electrical contact element and the second electrical contact element.

17. The connection assembly of claim 15, wherein the sleeve body has a non-circular cross-section.

18. The connection assembly of claim 15, wherein the first wire extends through the sleeve body and protrudes from the sleeve body at an end of the sleeve body, and the second wire extends through the sleeve body and protrudes from the sleeve body at the end of the sleeve body.

19. The connection assembly of claim 15, wherein the first electrical contact element is a first contact ring, and the second electrical contact element is a second contact ring.

20. The connection assembly of claim 15, wherein the sleeve body has an interior surface and an exterior surface,
wherein the first electrical contact element and the second electrical contact element are exposed at the exterior surface, and
wherein a region of the sleeve body is between the interior surface, and the first electrical contact element and the second electrical contact element.
